(19) United States
(12) Patent Application Publication
(10) Pub. No.: US 2024/0413519 A1
(43) Pub. Date: Dec. 12, 2024

(54) DISPLAY DEVICE AND LENS ASSEMBLY

(71) Applicants: INVENTEC (PUDONG) TECHNOLOGY CORPORATION, Shanghai (CN); INVENTEC CORPORATION, Taipei City (TW)

(72) Inventor: Chih-Cheng LI, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/236,894

(22) Filed: Aug. 22, 2023

(30) Foreign Application Priority Data
Jun. 7, 2023 (CN) 202310670764.0

(51) Int. Cl. H01Q 1/22; H01Q 15/02; H01Q 19/06

(52) U.S. Cl. CPC H01Q 1/2266; H01Q 15/02; H01Q 19/06

(57) ABSTRACT

A display device includes a casing, a display panel and a lens assembly. The casing includes a bottom plate, two side plates and a top plate. Two opposite sides of the two side plates are connected to the bottom plate and the top plate. The bottom plate, the two side plates and the top plate together form an accommodating space. The display panel and the lens assembly are located in the accommodating space. The lens assembly is disposed between the display panel and the top plate. The lens assembly includes a flexible circuit board, a lens and an antenna assembly. The flexible circuit board includes a flexible substrate and a ground structure. The ground structure is disposed on the flexible substrate. The lens is disposed on the flexible substrate. The antenna assembly is disposed on the flexible substrate, and is disposed between the lens and the top plate.

### CROSS-REFERENCE TO RELATED APPLICATIONS

This non-provisional application claims priority under 35 U.S.C. § 119(a) on Patent Application No(s). 202310670764.0 filed in China, on Jun. 7, 2023, the entire contents of which are hereby incorporated by reference.

### BACKGROUND OF THE INVENTION

### Technical Field of the Invention

The invention relates to a display device and a lens assembly, more particularly to a display device and a lens assembly integrating an antenna and a lens.

### Description of the Related Art

Nowadays, with the rapid development of Internet technology, applications of the Internet, such as receiving news information, contacting others or recording personal life, are indispensable to daily life of people. Recently, in order to meet requirements of the portability, wireless network has been widely used in the portable electronic devices, such as a laptop, a personal digital assistant or a smart phone.

Generally, antennas can be disposed in the portable electronic devices to transmit or receive signals so as to be connected to the Internet wirelessly. For example, manufacturers may install multiple antennas on two opposite sides of a laptop display panel. Accordingly, not only can a laptop be connected to the Internet wirelessly via the antennas, but also the antennas can be prevented from interfering with electronic components inside a casing of the laptop. To further broaden a frequency band of the signals which the antennas transmit and receive, manufacturers may additionally install other antennas on the portable electronic devices. However, spaces located on two opposite sides of the conventional laptop display panel are not enough to install additional antennas. Although the casing of the laptop may be designed to include additional assembly components for additional antennas, such additional assembly components increase the manufacturing cost of the laptop. Therefore, how to meet the requirement for the frequency band without increasing the manufacture cost of the laptop is an important issue to be solved.

### SUMMARY OF THE INVENTION

The invention provides a display device and a lens assembly so as to meet the requirement for the frequency band without increasing the manufacture cost of the display device.

One embodiment of the invention provides a display device including a casing, a display panel and a lens assembly. The casing includes a bottom plate, two side plates and a top plate. Two opposite sides of the two side plates are connected to the bottom plate and the top plate, respectively. The bottom plate, the two side plates and the top plate together surround and form an accommodating space. The display panel is located in the accommodating space. The lens assembly is located in the accommodating space, and is disposed between the display panel and the top plate. The lens assembly includes a flexible circuit board, a lens and an antenna assembly. The flexible circuit board includes a flexible substrate and a ground structure. The ground structure is disposed on the flexible substrate. The lens is disposed on the flexible substrate. The antenna assembly is disposed on the flexible substrate, and is electrically connected to the ground structure. The antenna assembly is disposed between the lens and the top plate.

Another embodiment of the invention provides a lens assembly configured to be disposed in a casing with an accommodating space, wherein the casing includes a top plate located next to the accommodating space. The lens assembly includes a flexible circuit board, a lens and an antenna assembly. The flexible circuit board includes a flexible substrate and a ground structure. The ground structure is disposed on the flexible substrate. The lens is disposed on the flexible substrate. The antenna assembly is disposed on the flexible substrate, and is electrically connected to the ground structure. The antenna assembly is at least partially disposed between the lens and the top plate.

According to the display device and the lens assembly disclosed by the above embodiments, since the antenna assembly and the flexible circuit of the lens assembly are integrally formed as a single piece, the antenna assembly can be disposed between the lens and the top plate. That is, a space over the lens can be provided to install the antenna assembly additionally. In addition, the antenna assembly matches the frequency band meeting the requirement of users. Therefore, not only can the requirement for the frequency band be meet, but also the antenna assembly can be disposed in the existing space over the lens without additional assembly components, thereby reducing a cost of additionally installing the antenna assembly on the display panel.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 is a perspective view of a display device in accordance with one embodiment of the invention;

FIG. 2 is a partially enlarged perspective view of the display device in FIG. 1; and

FIG. 3 is a plane view of the display device in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present invention, such as technical and scientific terms, have its own meanings and can be comprehended by those skilled in the art, unless the terms are additionally defined in the present invention. That is, the terms used in the following paragraphs should be read on the meaning commonly used in the related fields and will not be overly explained, unless the terms have a specific meaning in the present invention.

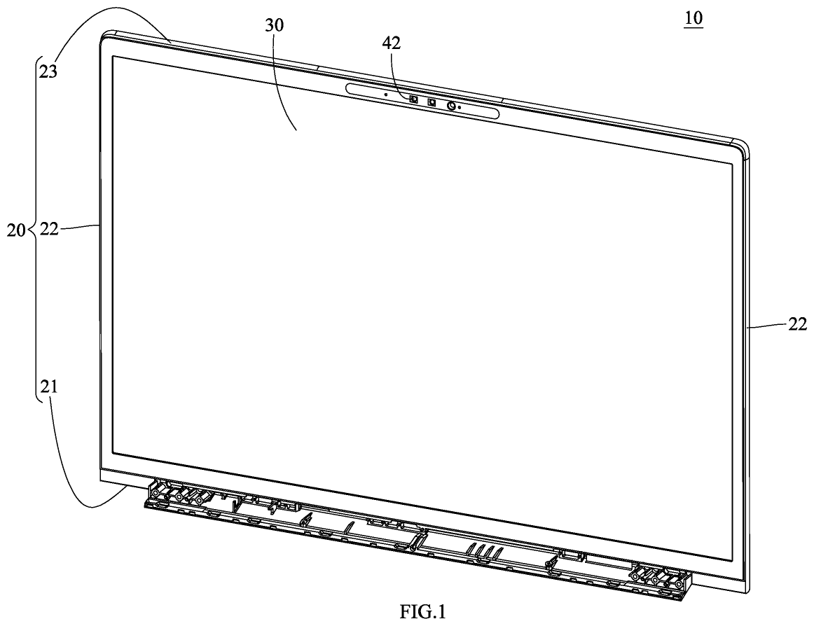

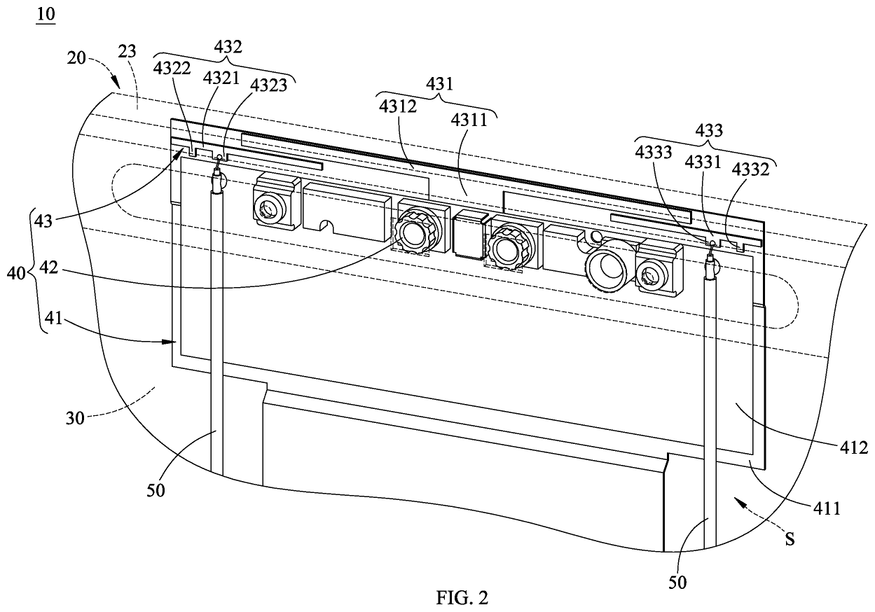

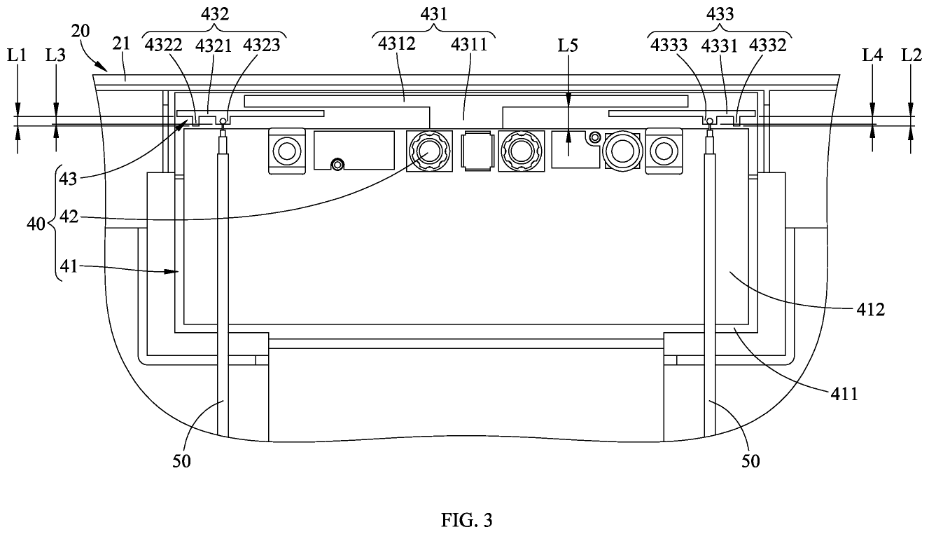

Please refer to FIG. 1 to FIG. 3, where FIG. 1 is a perspective view of a display device 10 in accordance with one embodiment of the invention, FIG. 2 is a partially enlarged perspective view of the display device 10 in FIG. 1, and FIG. 3 is a plane view of the display device 10 in FIG. 1.

In this embodiment, the display device 10 includes a casing 20, a display panel 30 and a lens assembly 40. The casing 20 includes a bottom plate 21, two side plates 22 and a top plate 23. Two opposite sides of the two side plates 22 are connected to the bottom plate 21 and the top plate 23, respectively. The bottom plate 21, the two side plates 22 and the top plate 23 together surround and form an accommodating space S. That is, the two side plates 22 and the top plate 23 are located adjacent to the accommodating space S. The display panel 30 is located in the accommodating space S. The lens assembly 40 is located in the accommodating space S, and is disposed between the display panel 30 and the top plate 23. That is, the lens assembly 40 is disposed in a space located above the display panel 30.

The lens assembly 40 includes a flexible circuit board 41, a lens 42 and an antenna assembly 43. The flexible circuit board 41 board includes a flexible substrate 411 and a ground structure 412. The ground structure 412 is disposed on the flexible substrate 411. The lens 42 disposed on the flexible substrate 411. The antenna assembly 43 is disposed on the flexible substrate 411, and is electrically connected to the ground structure 412. The antenna assembly 43 is disposed between the lens 42 and the top plate 23. That is, since the antenna assembly 43 is integrated on the flexible circuit board 41 of the lens assembly 40, the antenna assembly 43 can be disposed in a space located above the lens 42.

The antenna assembly 43 includes a first antenna unit 431, a second antenna unit 432 and a third antenna unit 433. The second antenna unit 432 and the third antenna unit 433 are symmetrically located at two opposite sides of the first antenna unit 431. The first antenna unit 431 includes a connecting portion 4311 and an extending portion 4312. An end of the connecting portion 4311 is electrically connected to the ground structure 412. Another end of the connecting portion 4311 is connected to a central portion of the extending portion 4312. The connecting portion 4311 is perpendicular to the extending portion 4312. That is, a direction along a major axis of the extending portion 4312 is perpendicular to a direction along which the connecting portion 4311 protrudes from the extending portion 4312. Accordingly, the first antenna unit 431 is T-shaped, and the first antenna unit 431 can match a frequency band in 1.7 gigahertz (GHz). That is, the first antenna unit 431 transmits or receives a signal in the frequency band in 1.7 GHz.

The second antenna unit 432 includes a line portion 4321, a first protruding portion 4322 and a second protruding portion 4323, and the third antenna unit 433 includes a line portion 4331, a first protruding portion 4332 and a second protruding portion 4333. The first protruding portions 4322, 4332 protrude from the line portion 4321, 4331, respectively, and are perpendicular to the line portion 4321, 4331, respectively. That is, a direction along a major axis of the line portion 4321 is perpendicular to a direction along which the first protruding portions 4322 protrudes from the line portion 4321, and a direction along a major axis of the line portion 4331 is perpendicular to a direction along which the first protruding portions 4332 protrudes from the line portion 4331. The second protruding portions 4323, 4333 protrude from the line portion 4321, 4331, respectively, and are perpendicular to the line portion 4321, 4331, respectively. That is, a direction along a major axis of the line portion 4321 is perpendicular to a direction along which the second protruding portions 4323 protrudes from the line portion 4321, and a direction along a major axis of the line portion 4331 is perpendicular to a direction along which the second protruding portions 4333 protrudes from the line portion 4331. The second protruding portions 4323 is closer to the connecting portion 4311 than the first protruding portions 4322, and the second protruding portions 4333 are closer to the connecting portion 4311 than the first protruding portions 4332. Accordingly, the second antenna unit 432 and the third antenna unit 433 are inverted F-shaped, and the second antenna unit 432 and the third antenna unit 433 can match a frequency band ranging from 3 GHz to 5 GHz. In addition, since a length L1 of the first protruding portion 4322, a length L2 of the first protruding portion 4332, a length L3 of the second protruding portion 4323 and a length L4 of the second protruding portion 4333 are less than a length L5 of the connecting portion 4311, the line portion 4321 of the second antenna unit 432 and the line portion 4331 of the third antenna unit 433 are at least partially located between the extending portion 4312 and the lens 42.

In this embodiment, spaces on opposite sides of the display panel 30 are not enough for the antenna assembly 43 to be disposed additionally. Therefore, the antenna assembly 43 is integrated on the flexible circuit board 41 of the lens assembly 40, so that the space located above the lens 42 can be used to install the antenna assembly 43 additionally. In addition, the antenna assembly 43 matches the frequency band meeting the requirement of users. Accordingly, the antenna assembly 43 can be disposed in the existing space located above the lens 42 without additional assembly components. Thus, the requirement for the frequency band can be meet without increasing the manufacture cost of the display device 10.

In this embodiment, the display device 10 further includes two cables 50. The two cables 50 are electrically connected to the second protruding portion 4323 of the second antenna unit 432 and the second protruding portion 4333 of the third antenna unit 433, respectively, so that a power supply (not shown) of the display device 10 can provide power to the second antenna unit 432 and the third antenna unit 433 via the two cables 50.

According to the display device and the lens assembly disclosed by the above embodiments, since the antenna assembly is integrated on the flexible circuit of the lens assembly, the antenna assembly can be disposed between the lens and the top plate. That is, the space located above the lens can be used to install the antenna assembly additionally. In addition, the antenna assembly matches the frequency band meeting the requirement of users. Therefore, the antenna assembly can be disposed in the existing space located above the lens without additional assembly components. Thus, the requirement for the frequency band can be meet without increasing the manufacture cost of the display device.

It will be apparent to those skilled in the art that various modifications and variations can be made to the present invention. It is intended that the specification and examples be considered as exemplary embodiments only, with the scope of the invention being indicated by the following claims and their equivalents.

What is claimed is:

1. A display device, comprising:
a casing, comprising a bottom plate, two side plates and a top plate, wherein two opposite sides of the two side plates are connected to the bottom plate and the top plate, respectively, and the bottom plate, the two side plates and the top plate together surround and form an accommodating space;
a display panel, located in the accommodating space; and
a lens assembly, located in the accommodating space and disposed between the display panel and the top plate, wherein the lens assembly comprises:
a flexible circuit board, comprising a flexible substrate and a ground structure, wherein the ground structure is disposed on the flexible substrate;
a lens, disposed on the flexible substrate; and
an antenna assembly, disposed on the flexible substrate and electrically connected to the ground structure, wherein the antenna assembly is disposed between the lens and the top plate.

2. The display device according to claim 1, wherein the antenna assembly comprises a first antenna unit, a second antenna unit and a third antenna unit, the second antenna unit and the third antenna unit are symmetrically located at two opposite sides of the first antenna unit, and at least a part of the second antenna unit and at least a part of the third antenna unit are located between the first antenna unit and the lens.

3. The display device according to claim 2, wherein the first antenna unit comprises a connecting portion and an extending portion, an end of the connecting portion is electrically connected to the ground structure, another end of the connecting portion is connected to a central portion of the extending portion, the connecting portion is perpendicular to the extending portion, and the first antenna unit is T-shaped.

4. The display device according to claim 3, wherein each of the second antenna unit and the third antenna unit comprises a line portion, a first protruding portion and a second protruding portion, the first protruding portion and the second protruding portion protrude from the line portion, the first protruding portion and the second protruding portion are perpendicular to the line portion, the second protruding portion is closer to the line portion than the first protruding portion, and the second antenna unit and the third antenna unit are inverted F-shaped.

5. The display device according to claim 4, wherein a length of the first protruding portion of the second antenna unit, a length of the second protruding portion of the second antenna unit, a length of the first protruding portion of the third antenna unit and a length of the second protruding portion of the third antenna unit are less than a length of the connecting portion, and the line portion of the second antenna unit and the line portion of the third antenna unit are at least partially located between the extending portion and the lens.

6. The display device according to claim 4, further comprising two cables, wherein the two cables are electrically connected to the second protruding portion of the second antenna unit and the second protruding portion of the third antenna unit, respectively.

7. A lens assembly, configured to be disposed in a casing with an accommodating space, wherein the casing comprises a top plate located adjacent to the accommodating space, comprising:
a flexible circuit board, comprising a flexible substrate and a ground structure, wherein the ground structure is disposed on the flexible substrate;
a lens, disposed on the flexible substrate; and
an antenna assembly, disposed on the flexible substrate and electrically connected to the ground structure, wherein the antenna assembly is at least partially disposed between the lens and the top plate.

8. The lens assembly according to claim 7, wherein the antenna assembly comprises a first antenna unit, a second antenna unit and a third antenna unit, the second antenna unit and the third antenna unit are symmetrically located at two opposite sides of the first antenna unit, and at least a part of the second antenna unit and at least a part of the third antenna unit are located between the first antenna unit and the lens.

9. The lens assembly according to claim 8, wherein the first antenna unit comprises a connecting portion and an extending portion, an end of the connecting portion is electrically connected to the ground structure, another end of the connecting portion is connected to a central portion of the extending portion, the connecting portion is perpendicular to the extending portion, and the first antenna unit is T-shaped.

10. The lens assembly according to claim 9, wherein each of the second antenna unit and the third antenna unit comprises a line portion, a first protruding portion and a second protruding portion, the first protruding portion and the second protruding portion protrude from the line portion, the first protruding portion and the second protruding portion are perpendicular to the line portion, the second protruding portion is closer to the line portion than the first protruding portion, the second antenna unit and the third antenna unit are inverted F-shaped, a length of the first protruding portion of the second antenna unit, a length of the second protruding portion of the second antenna unit, a length of the first protruding portion of the third antenna unit and a length of the second protruding portion of the third antenna unit are less than a length of the connecting portion, and the line portion of the second antenna unit and the line portion of the third antenna unit are at least partially located between the extending portion and the lens.
